(19) United States
(12) Patent Application Publication
(10) Pub. No.: US 2014/0129276 A1
(43) Pub. Date: May 8, 2014

(54) METHOD AND SYSTEM FOR SUPPLIER MANAGEMENT

(71) Applicant: SIRION LABS, Gurgaon (IN)

(72) Inventors: AJAY AGRAWAL, NEW DELHI (IN); KANTI PRABHA, GURGAON (IN); ADITYA GUPTA, GURGAON (IN); ISHA JHA, NEW DELHI (IN)

(73) Assignee: SIRION LABS, GURGAON (IN)

(21) Appl. No.: 13/721,100

(22) Filed: Dec. 20, 2012

(30) Foreign Application Priority Data
Nov. 7, 2012 (IN) 3462/DEL/2012

(51) Int. Cl. G06Q 10/06

(52) U.S. Cl. CPC G06Q 10/0637
USPC 705/7.15; 705/7.13; 705/7.36

(57) ABSTRACT

A method for supplier management is described. The method includes storing metadata related to several executed contracts in a contract library, each contract having one or more deliverables. Further, the method involves normalizing the metadata into a predetermined form. Selecting a deliverable from a contract entered into the contract library, the method identifies one or more deliverables from the contract library that are similar to the selected deliverable. The method then compares the selected deliverable's metadata to the metadata of the identified deliverables and based on the comparison, determines whether the deliverable is likely to be missed. If the deliverable is likely to be missed, the method performs an appropriate action which can include one or more of sending a notification, arranging additional monitoring, modifying benchmarks/thresholds, or suggesting renegotiation of the deliverable. A system for supplier management is also described.

### BACKGROUND

Today, organizations face the challenge of harvesting value from their service contracts, and although mature governance strategies and supply chain management technology already exist for product contracts, the comprehensive governance strategy for service contracts is still evolving.

Technology and services for managing service deliverables (service level agreements, obligations, milestones, etc.) within services contracts, as well as reactive management reporting, already exist, but there is little real time information about the performance of these deliverables. Presently, no streamlined mechanism exists for learning from previously implemented service contracts and identifying performance patterns. For example, managers would find great value in identifying how a supplier performs on certain types of deliverables, enabling the client to identify deliverables prone to failure, which then may be handled with added vigilance.

Besides learning from previously implemented contracts, analysis of invoices and associated performance credits and earnbacks, spend pools, resource baseline usage, chargebacks, and contract pricing adjustments also indicate the health of processes, deliverables, and client-supplier relationships. It would be useful to have a mechanism to delineate deliverables and relationships at risk, so that appropriate action can be taken proactively.

Clients face an additional challenge in that suppliers provide performance data emanating from different systems, such as network management systems, invoice management systems, performance management systems, etc. These systems may be proprietary, or various sorts of third-party systems and databases. Consequently, a client receives performance reports and invoices from each of their suppliers, generated by numerous disparate systems. Consolidating this data is not only arduous but extremely expensive.

For large client organizations, this problem is further exacerbated by their multifarious nature. Large client organizations generally include a number of different business units or geographic it centers, each purchasing products and services from different suppliers. The sheer volume of data can inundate the processing capacity. Moreover, validating these reports and invoices is extremely difficult, as the client cannot meaningfully compare data across multiple suppliers.

Therefore, a need exists for systems that enable proactive approach to analyzing and learning from previously-implemented contracts, as well as standardizing real-time performance data.

### BRIEF DESCRIPTION OF THE FIGURES

FIG. 1 illustrates an exemplary system for adaptive supplier management.

FIG. 2 illustrates an exemplary contract definition.

FIGS. 3A, 3B, and 3C illustrate an exemplary method for normalizing the extracted metadata of FIGS. 1 and 2.

FIG. 4 depicts an exemplary method for supplier management within the system of FIG. 1.

FIG. 5 illustrates an exemplary method for invoice management through the exemplary system of FIG. 1 and the exemplary contract definition of FIG. 2.

FIG. 6 depicts an exemplary method for performing retrospective supplier management.

FIG. 7 illustrates an SLA status report comparing SLA performance across different suppliers in a given month.

FIG. 8 depicts a chart showing five suppliers having the lowest credit on their invoices over the past year.

FIG. 9 shows a chart representing the task completion status for three tasks.

FIG. 10 depicts a chart representing the top four clients that pay their invoices on time and the percentage of such invoices.

### SUMMARY

One embodiment of the disclosure describes a method for supplier management including storing metadata related to several executed contracts in a contract library, each contract having one or more deliverables. Further, the method involves normalizing the metadata into a predetermined form. Selecting a deliverable from a contract entered into the contract library, the method identifies one or more deliverables from the contract library that are similar to the selected deliverable. The method then compares the selected deliverable's metadata to the metadata of the identified deliverables and based on the comparison, determines whether the deliverable is likely to be missed. If the deliverable is likely to be missed, the method performs an appropriate action which can include one or more of sending a notification, arranging additional monitoring, modifying benchmarks/thresholds, or suggesting renegotiation of the deliverable.

Another embodiment of the disclosure describes a system for adaptive supplier management including a contracts library that stored metadata related to several executed contracts, each contract having one or more deliverables. An analytics module in the system normalizes the metadata into a predetermined form and selects a deliverable from a contract entered into the contract library. The analytics module identifies one or more deliverables from the contract library that are similar to the selected deliverable and compares the selected deliverable's metadata to the metadata of the identified deliverables. Based on the comparison, the analytics module determines whether the deliverable is likely to be missed. On determining that the deliverable is likely to be missed, the analytics module performs an appropriate action, including one or more of sending a notification, arranging additional monitoring, modifying benchmarks/thresholds, or suggesting renegotiation of the deliverable.

### DETAILED DESCRIPTION

The following detailed description is made with reference to the figures. Preferred embodiments are described to illustrate the disclosure, not to limit its scope, which is defined by the claims. Those of ordinary skill in the art will recognize a number of equivalent variations in the description that follows.

### Overview

The disclosed embodiments describe methods and systems for supplier management. A contract library stores storing metadata related to several executed contracts, each contract having one or more deliverables. The metadata is normalized into a predetermined form. Selecting a deliverable from a contract entered into the contract library, one or more deliverables similar to the selected deliverable are identified from the contract library. The selected deliverable's metadata is then compared to the metadata of the identified deliverables, and based on the comparison, it is determined whether the deliverable is likely to be missed. If the deliverable is likely to be missed, an appropriate action, which can include sending a notification, arranging additional monitoring, modifying benchmarks/thresholds, suggesting renegotiation of the deliverable, or any combination of these, is performed. In this manner, the embodiments of the present disclosure facilitate proactive prediction of performance and allow pre-emptive action to be taken.

### Description of Exemplary Embodiments

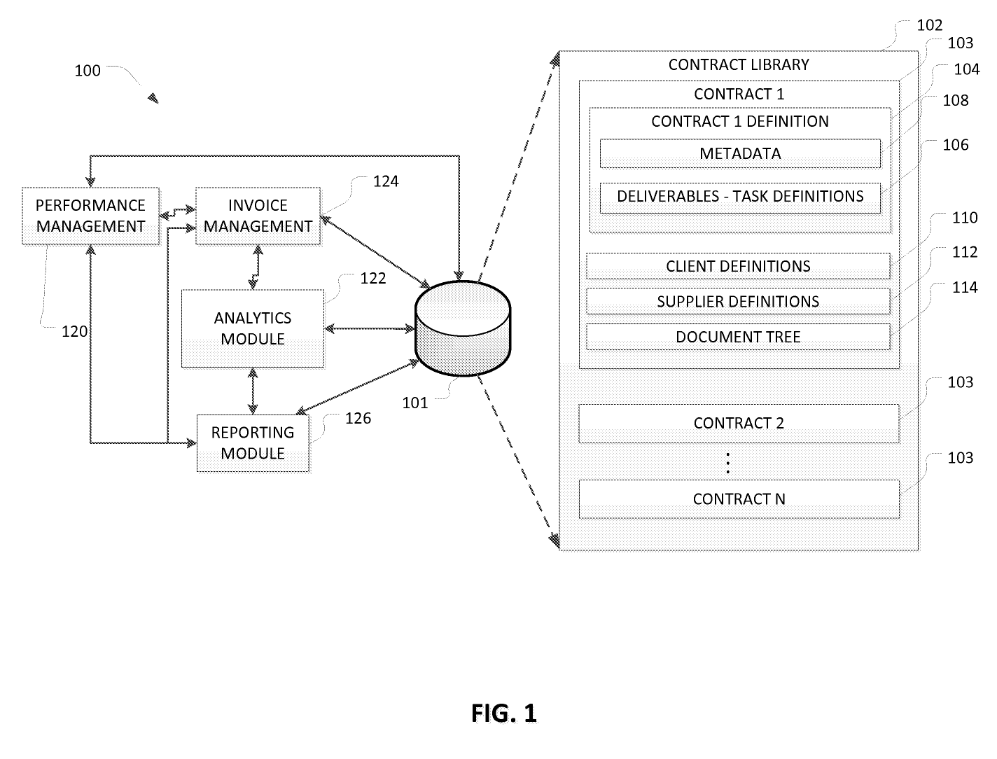

FIG. 1 illustrates an exemplary system 100 for supplier management. The system 100 may be rendered as a desktop application, a web application, a cloud application, or in any other form known in the art or hereafter developed. The system 100 includes a relational database 101 that stores data concerning several executed contracts, and this database can be represented as a contract library 102 described below. It will be understood by those in the art that the relational database 101 can be queried in various ways to retrieve any type of data view depending on business requirements and user preferences. The contract library 102 described below is one such data view.

The contract library 102 organizes data from the relational database 101 into several contracts 103—contract 1 103, contract 2 103, . . . contract n 103. Each contract 103 may include its own contract definition 104, together with client definitions 110 and supplier definitions 112. A document tree 114 is a hierarchically arranged set of all documents that form the contract 103.

The contract definition 104 includes task definitions 106 and metadata 108. The task definitions 106 include all deliverables mentioned within a contract 103, as well as related tasks to be performed in order to meet the deliverables. The metadata 108 can include all general information about the contract 103, such as the start date, end date, geography involved, services being delivered, document name, complexity of contract, contract value, etc.

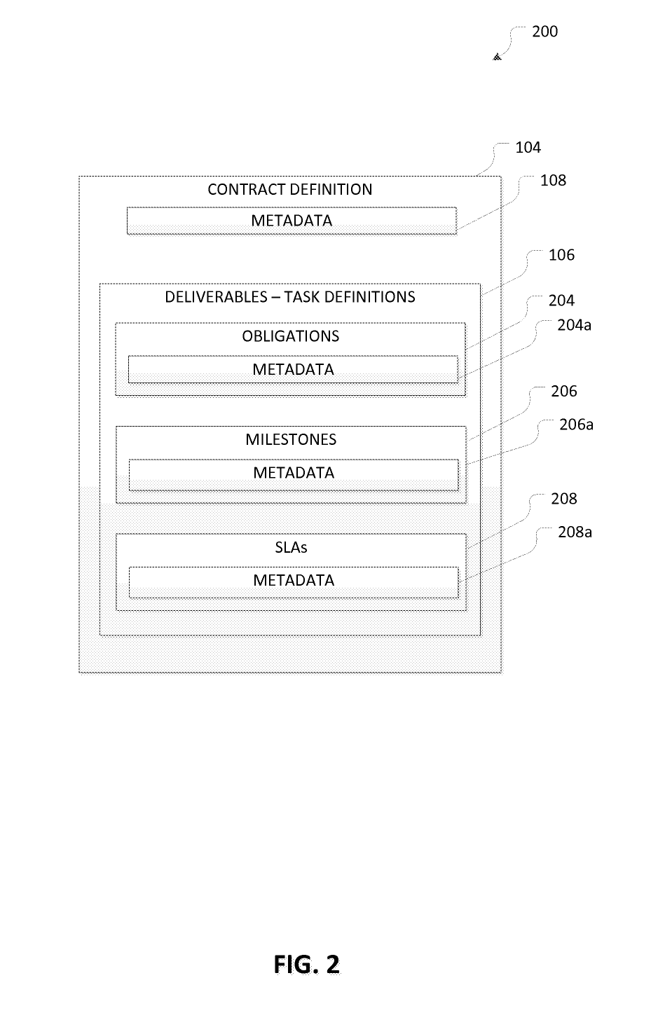

Several modules process the contract data. A performance management module 120 tracks metadata of each deliverable through the task definitions 106, the supplier definitions 112, and the client definitions 110. An analytics module 122 is connected to performance management module 120, and it compares a particular task definition to the data in the relational database 101 to yield insights, as discussed in more detail below. The analytics module 122 can also automatically extract deliverables from a contract document along with the corresponding task definitions 106, described in more detail in connection with FIG. 2. The automatic extraction may be performed using various methods, for example, keyword or phrase recognition based on a built-in glossary, search algorithms, learning algorithms, or other applicable algorithms known in the art. Some examples of this automatic extraction include but are not limited to automatically identifying the owner, client, supplier, and other stakeholders for a given contract. Alternatively, the system may automatically identify and extract information such as the contract term, start date, end date, frequency of tasks, deadlines, milestones, obligations, SLAs, service rates, and similar information.

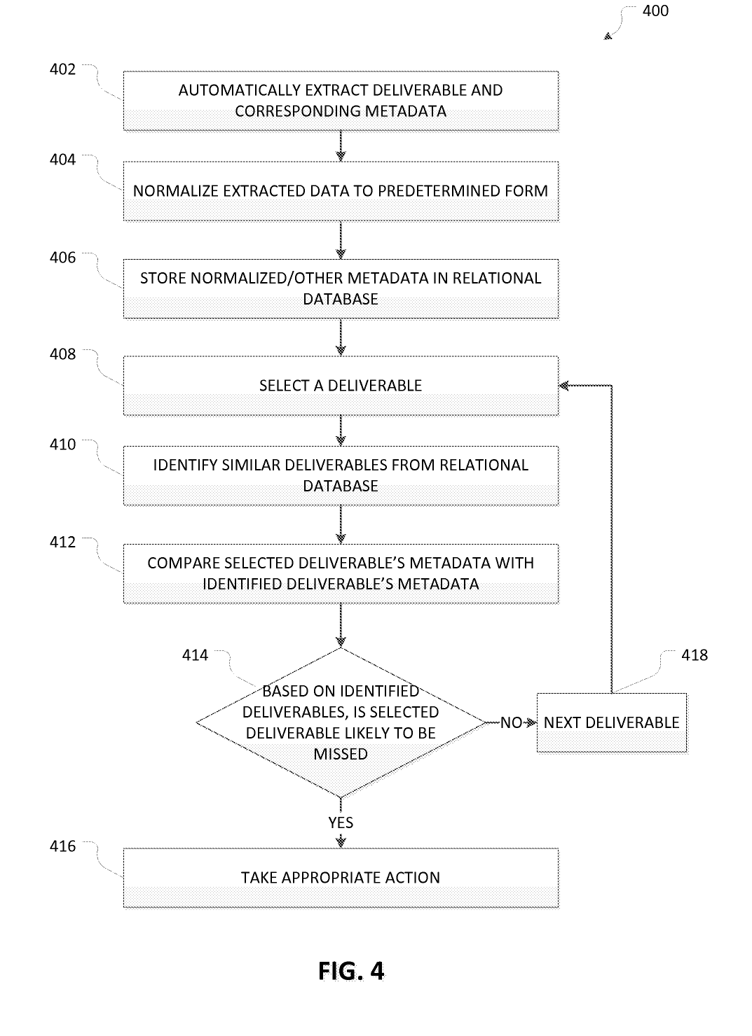

The system 100 may also include an invoice management module 124 for managing one or more invoices related to the contracts, as described in relation with FIG. 6. Further, the system 100 may also have a reporting module 126 to display, for instance, the comparison between the deliverable definition and the corresponding task status in the form of graphs, charts, or tables, among other comparisons and analysis results.

FIG. 2 illustrates an exemplary view 200 of a contract definition 104. As noted above, contract definition 104 includes deliverable task definitions 106 and metadata 108. The deliverable task definitions 106 include but are not limited to obligations 204 (having corresponding metadata 204a), milestones 206 (having corresponding metadata 206a), and service level agreements (SLAs) 208 (having corresponding metadata 208a).

The metadata 204a, 206a, and 208a, corresponding to obligations 204, milestones 206 and SLAs 208, respectively, may be, an extract of a deliverable clause, deliverable description, calculation formulae, deadlines, stakeholders, start or end dates, duration, financial value, contract phase, relationship to other modules such as issue management module, performance management module, invoice management module, etc.

The metadata 108, 204a, 206a, and 208a extracted from the contract 103 are then normalized to a predetermined form. Those skilled in the art will understand that all extracted metadata 108, 204a, 206a, and 208a may not be normalized. For instance, some parts of an SLA clause extracted from the contract may be normalized, but the extract is also stored as separate metadata. Other examples of metadata 108, 204a, 206a, and 208a which may not be normalized can include deliverable description, calculation formulae, etc. Such metadata 108, 204a, 206a, and 208a may be stored in the form of a direct contract extract, a user entry, or a combination of these.

The analytics module 122 normalizes the extracted metadata 108, 204a, 206a, and 208a across different types of suppliers, clients, tasks, etc. Such normalization can allow, for example, comparison across different supplier types that may belong to different vocational fields or industry areas.

### Normalization of Metadata

Normalization of the extracted data can involves cleansing and standardizing the automatically extracted metadata to a suitable format. It can also involve defining descriptive metadata properties or ‘synthetic parameters’ and then mapping the extracted contract metadata to corresponding predefined synthetic parameters, as will be described. The synthetic parameters can be attached to the contract data at any level.

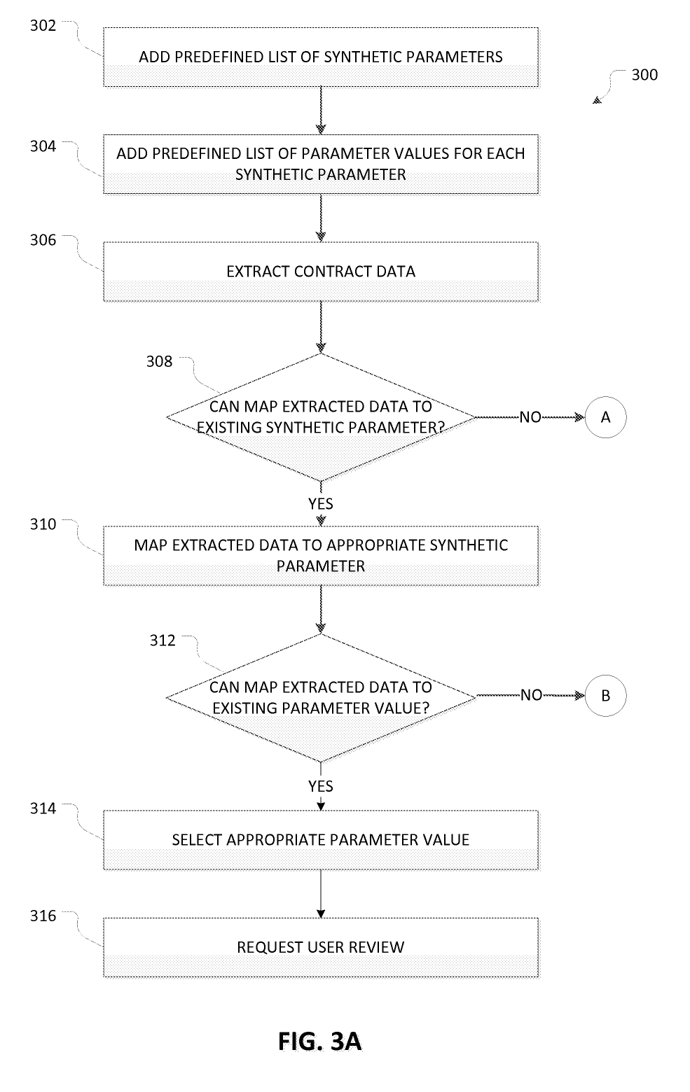

FIGS. 3A, 3B, and 3C illustrate an exemplary method 300 for normalizing the extracted metadata 108, 204a, 206a, and 208a. At step 302, a predefined list of synthetic parameters is added to the relational database 101, and at step 304 a predefined list of parameter values for each synthetic parameter is uploaded into the relational database 101.

Contract data, such as a contract clause, is extracted at step 306, as discussed in relation to FIGS. 1 and 2. At step 308, the analytics module 122 determines whether the extracted data can be mapped to a synthetic parameter from the predefined list of synthetic parameters. If the analytics module 122 determines that such a mapping is possible, it performs the mapping at step 310.

Similarly, the analytics module 122 also attempts to extract a value for the synthetic parameter from the contract data. If the analytics module 122 determines that it can map the extracted contract data to one of the parameter values in the predefined list for the synthetic parameter at step 312, it selects the appropriate parameter value from the predefined list of parameter values, at step 314. At step 316, the system 100 may request the user to review the synthetic parameter mapping and the corresponding parameter value selection. Such user intervention may be contingent on predefined business rules in the system 100.

At step 308, if the analytics module is unable to map an existing synthetic parameter to the extracted contract data, it proceeds to step 318, through connector A, and requests user input. At step 320, the user attempts to choose an applicable synthetic parameter that can be mapped to the extracted data. If the user is able to select a synthetic parameter from the predefined list of synthetic parameters that maps to the extracted contract data, the relational database 101 stores this mapping. Further, at step 322, the analytics module 122 learns from this user selection, which may involve taking note of the selection. For example, if the same user selection occurs more than once, then subsequently, the method 300 makes the same synthetic parameter selection automatically. The method 300 may employ various learning algorithms known in the art for learning from user input.

At step 320, if the user is unable to select one of the existing options from the predefined list of synthetic parameters, the method 300 prompts the user to create a new synthetic parameter at step 324. If the user chooses to create a new synthetic parameter at step 326, the system 100 may take the user through the steps of adding a new synthetic parameter to the predefined list of synthetic parameters, assign a corresponding list of parameter values, and define business rules for automatic mapping of contract data to the new synthetic parameter and corresponding parameter values, at step 328. If however, at step 326, the user chooses not to add a new synthetic parameter to the predefined list of synthetic parameters, the method 300 stores the extracted contract data in another configurable metadata field in the relational database 101. This may be performed automatically by the system 100 or through user input.

At step 312, if the analytics module is unable to map an existing parameter value to the extracted contract data, it proceeds to step 332, through connector B, and requests user input. At step 334, the user attempts to choose an applicable parameter value that can be mapped to the extracted data. If the user is able to select a parameter value from the predefined list of parameter values that maps to the extracted contract data, the relational database 101 stores this mapping. Further, at step 336, the analytics module 122 learns from this user selection, which may involve taking note of the selection. For example, if the same user selection occurs more than once, then subsequently, the method 300 makes the same parameter value selection automatically. The method 300 may employ various learning algorithms known in the art for learning from user input.

At step 334, if the user is unable to select one of the existing options from the predefined list of parameter value, the method 300 prompts the user to create a new parameter value at step 338. If the user chooses to create a new parameter value at step 340, the system 100 may take the user through the steps of adding a new parameter value to the predefined list of parameter values, and define business rules for automatic mapping of contract data to the new parameter value, at step 342. If however, at step 340, the user chooses not to add a new parameter value to the predefined list of parameter value, the method 300 allows the user to make a one-time manual entry for the parameter value at step 344.

The examples below describe normalization of extracted contract data to synthetic parameters present in the list of predefined synthetic parameters.

### Example 1

Synthetic Parameter—Supplier Name: The system 100 includes a predefined list of possible supplier names, which is the set of parameter values. The analytics module 122 extracts the supplier from the contract 103 and will attempt to map it to one of the suppliers in the predefined list of supplier names. If the analytics module 122 can map the extracted supplier to an existing supplier name in the predefined list, it assigns the supplier name identified from the predefined list. If analytics module 122 does not find a mapping supplier name, it will prompt the user to enter the supplier name manually and may add the entered supplier name to the predefined list of supplier names.

### Example 2

Synthetic Parameter—Client Name: Similar to the ‘Supplier Name’ synthetic parameter, the client name extracted from the contract 103 may be mapped to one of the client name parameter values in a predefined list of client names. If the analytics module 122 does not find a mapping client name, it will prompt the user to enter the client name manually and may add the entered client name to the predefined list.

### Example 3

Synthetic Parameter—Service: The service type of a contract 103 can be selected from a predefined list that may include parameter values such as Information Technology, Human Resources, Finance and Accounting, etc. Depending on the services outlined in the contract 103, the analytics module 122 can apply the appropriate parameter value and prompt the user to provide additions or edits.

### Example 4

Synthetic Parameter—Sub-Service: Consider that synthetic parameter ‘service’ is identified as IT in example 3 above. The analytics module 122 then attempts to identify the sub-services being provided in the contract 103. Alternatively, analytics module 122 may request the user to select the sub-services present in the contract 103 from a drop down menu that includes parameter values, such as end user computing, web hosting, infrastructure, application development, application maintenance, management network services, data centers, help desk, and service integration.

### Example 5

Synthetic Parameter—Geography: The system 100 includes a parameter value list that includes names of various geographies that may be organized by region, country, continent, etc. Here again, the analytics module 122 may extract geographies from the contract 103 and attempt to map these to the parameters values in the list of geographies. A user may also add to or edit the geography parameter values mapped to the contract 103.

### Example 6

Synthetic parameters related to a transition milestone: Based on natural language programming, the analytics module 122 identifies contract 102 clause as being a milestone for the transition of services. The analytics module 122 can extract various synthetic parameters related to the transition milestone from the clause, for instance, start date, end date, duration, charges, milestone type, and so on.

In certain cases, although the analytics module 122 can identify a contract clause as being related to a transition milestone, it may not be able to identify any synthetic parameters within the clause language. In this case, the analytics module 122 will request user input and may add a new synthetic parameter to the predefined list of synthetic parameters, as discussed in connection with steps 310 to 330 above.

The progress of the transition milestone may be tracked in the performance management module 120 and the payment of related charges can be tracked in the invoice management module 124. In this manner, every milestone in the contract 103 can be captured as a predefined set of synthetic parameters, which can be compared and analyzed. For example, timeliness of milestone achievement, payment of charges, etc. can be compared across different contracts 103.

### Example 7

Synthetic Parameter—SLA: Consider that for a contract 103 the synthetic parameters ‘service’ and ‘sub-service’ are IT and help desk, respectively. For help desk contracts 103, the system 100 includes a predefined list of SLA parameter values, such as first-call problem resolution, percentage of problems resolved, percentage of problems closed and not reopened, speed to answer by voice response unit, call abandon rate, and authorized user satisfaction rating. During data extraction from the contract 103, the analytics module 122 identifies an SLA clause in the contract 103 and attempts to map it to one of the corresponding parameter values.

Normalization may also include standardization of format, some examples of which include, but are not limited to, standardizing phrases ‘fortnightly’, ‘bimonthly’ and other similar phrases in a contract to every two weeks' or standardizing date formats.

This normalization can involve predetermined calculations on the metadata.

It will be understood by those in the art that the examples provided above do not limit the scope of ‘synthetic parameters’ or ‘parameter values’, which are only limited by the scope of the claims. Synthetic parameters may be defined for any type of contract data which can be mapped to a predefined set of parameter values, such that any extracted contract data may be mapped to a corresponding synthetic parameter, and its value may be selected from selected from a predefined set of parameter values of that synthetic parameter. Alternatively, the parameter value may be configurable by a user. In another implementation, an administrator of the system 100 is able to add a parameter value to the predefined set of parameter value.

If however, the analytics module 122 is unable to map the extracted contract data to an existing synthetic parameter, an administrator of the system 100 is able to create a new synthetic parameter and define rules for the automated extraction of contract data that maps to this synthetic parameter.

### Proactive Supplier Management

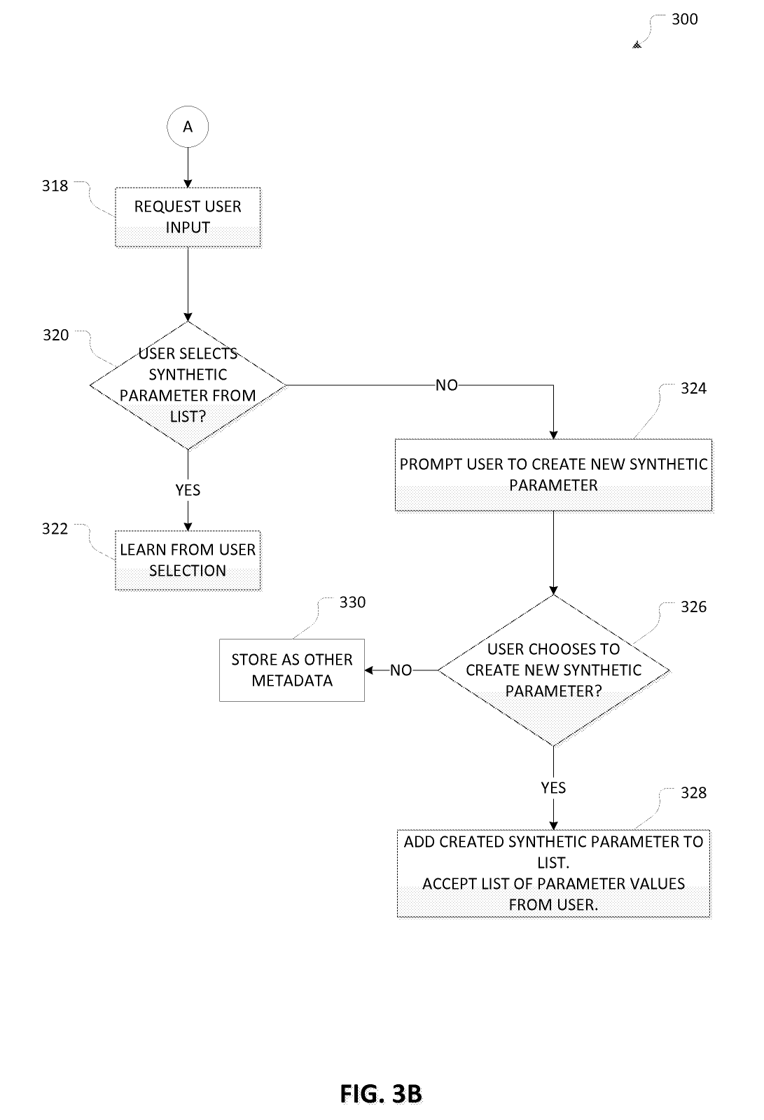

FIG. 4 depicts an exemplary method 400 for supplier management within the system 100. At step 402, the method 400 automatically extracts deliverables 204, 206, and 208 from a contract 103 and the corresponding contract definition metadata 108 and deliverable metadata 204a, 206a, and 208a, respectively. It will be understood that the metadata 108, 204a, 206a, and 208a may alternatively be extracted from other systems through, for example, an API (or any such technology bridge known in the art) that facilitates data extraction from the other system, which may be a contract management system, a financial system, and invoice management system, an issue tracking system, or any other system that can provide metadata for the contract 103.

The analytics module 122 normalizes the metadata 108, 204a, 206a, and 208a to a predetermined form at step 404, as described above in connection with FIG. 3. Then it stores the normalized metadata, along with any other metadata 108, 204a, 206a, and 208a that was not normalized, in the relational database 101 at step 406.

Once deliverables 106 have been automatically extracted from a contract 104, the method 400 can predict whether a selected deliverable 106 within a contract 104 is likely to be missed.

The analytics module 122 selects a deliverable 106 from this contract at step 408 and proceeds to identify one or more deliverables 106 similar to the selected deliverable 106 from the relational database 101 at step 410. Here, similarity may be established by comparison of metadata including the parameter values of the synthetic parameters or other metadata attached to each deliverable 106. Consider an example where the selected deliverable 106 has the following synthetic parameter values—‘Service’ is IT, ‘Sub-service’ is Help Desk, ‘Deliverable Type’ is SLA and ‘SLA’ is call abandon rate. The analytics module 122 then searches for other SLAs in the relational database 101 that have the same synthetic parameter values. Further, the analytics module 122 may further establish similarity through other stored metadata as well, such as supplier name or year of contract.

Based on the identified deliverables 106, the analytics module 122 then compares metadata from the selected deliverable 106 with metadata from the identified deliverable 106 (step 412) to determine whether the selected deliverable 106 is likely to be missed at step 414. This determination may be based on status, progress patterns, or other performance data of the identified deliverables 106 available in the performance management module 120. The patterns can be extrapolated to fit the selected deliverable 106 and thus, to the system can predict how the selected deliverable 106 will perform.

If it is determined that the selected deliverable 106 is likely to be missed, based on the fact, for example, that the identified similar deliverables 106 were also missed, the analytics module 122 will take appropriate action at step 416. Such action may include, but is not limited to, sending a notification to the stakeholders with the prediction; arranging additional monitoring for the selected deliverable 106; modifying benchmarks and thresholds related to the deliverable, for example, if the threshold for escalation is missing the selected deliverable 106 two months is a row, the threshold may be reduced to one month; or suggesting renegotiation of the deliverable. Alternatively, if the deliverable 106 is not likely to be missed, then the method 400 proceeds to select another deliverable 106 for prediction at step 418.

Consider another example where SLAs have been automatically extracted from a new contract entered into the relational database 101. One deliverable definition states that if at least 97% of the SLAs in the contract are met in a month, the SLA status for the month is green; otherwise the SLA status for the month is red. The analytics module 122 identifies similar deliverables from the relational database 101 and uses the supplier, service, sub-service, and SLA type as the similarity criterion. For this supplier, if the relational database 101 shows that the SLA status remained green for the first quarter of the year, and then dropped to red for the remainder of the year, the analytical module 122 will schedule weekly meetings for the discussion of the deliverable with the supplier.

### Invoice Management

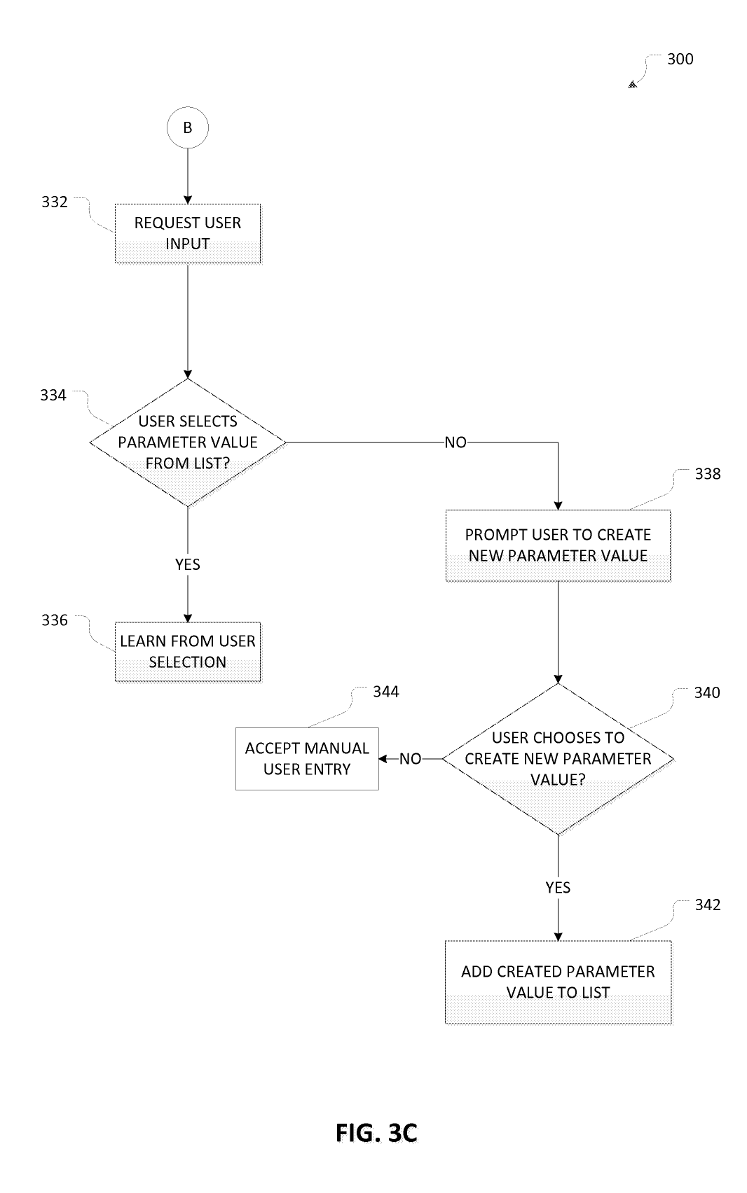

FIG. 5 illustrates an exemplary method 500 for invoice management through the system 100 and exemplary view 200. At step 501, the method 500 tracks metadata of each deliverable 106.

The performance management module 120 determines status of tasks 114 related to a deliverable 106 at step 502. The analytics module 122 receives the status information from the performance management module 120 and compares a deliverable definition 106 with the corresponding task status at step 504 to determine whether the deliverable 106 has been met at step 506. If the deliverable 106 has been met, the analytics module 122 credits a reward to the corresponding invoice at step 508, if such a provision exists in the deliverable definition 106. Otherwise, if the deliverable 106 is not met, the analytics module 122 credits a penalty to the corresponding invoice at step 510, if such a provision exists in the deliverable definition 106. The penalty may be applied in the form of financial credits that may be earned back later or other similar instruments known in the art. The applied penalties and rewards may affect the monetary values of the related invoices. After steps 508 and 510, the method 500 proceeds to an optional step 512, sending a notification of any credits that may have been made to the respective stakeholders. The information about the applied rewards or penalties is also passed on to the invoice management module 124.

The task definition 106 may define a mathematical rule set to be used for determining the task 114 status. For example, a task definition 106 could provide that at least 95% of the IT tickets produced in a month must be close within 15 minutes, otherwise the deliverable 106 is not met. The performance management module 120 includes a monthly task 114 which utilizes a percentage formula to calculate the percentage of IT tickets closed in 15 minutes at the end of each month. The analytics module 122 compares this calculated percentage with the 95% mentioned in the deliverable definition 106. If the calculated percentage is equal or greater, the deliverable 106 has been met; otherwise the deliverable is not met. The task definition 106 may also define corresponding rewards or penalties to be applied to the related invoices.

### Retrospective Supplier Management

FIG. 6 depicts an exemplary method 600 for performing retrospective supplier management. It is possible for the analytics module 122 to analyze the invoices, which may analyze the patterns of penalties, rewards, credits, earnbacks, Reduced Resource Credits (RRCs), Additional Resource Charges (ARCs), and other similar financial criteria known in the art to indicate how the task 106 is performing and how it may perform in the future. Further, the analytics module 122 may have predetermined benchmarks and thresholds, based on which the analytics module 122 can take action to improve the performance of a task 106.

The method 600 involves the analytics module 122 analyzing an invoice for a contract 103 at step 602. At step 604, the analytics module 122 determines whether a first threshold is reached. If yes, the method 600 proceeds to step 606, where the analytics module 122 determines whether a second threshold is reached; otherwise, the method 600 returns to step 602, where it analyzes the next invoice.

If at step 606, the method 600 determines that the second threshold is reached, the method 600 proceeds to step 608 to determine whether a third threshold is reached. If the second threshold is not reached, the analytics module suggests additional monitoring of the task 106 at step 610. Such a suggestion may involve sending a notification to all stakeholders, scheduling a weekly meeting for further discussion, and so on.

At step 608, if it is determined that the third threshold is not reached, the analytics module 122 modifies benchmarks and thresholds related to the task 106 at step 612. However, if the third threshold has been reached, the analytics module 122 suggests renegotiating deliverable 106 at step 614 to ensure that deliverable 106 expectations are reasonable and its performance is not jeopardized. It will be apparent to those in the art that all action taken by the analytics module 122 may be in the form of or accompanied by a notification to all stakeholders.

In one exemplary implementation, in the invoices for a contract 103, the first threshold may be set in case a credit is present on the invoice. Crossing this first threshold will result in a notification being sent to the stakeholders, who may look into the cause of the credit and attempt to remedy it. However, over a period of several months, it may be noticed that each time a credit takes place, it is compensated by an earnback in the following month. Keeping this in mind, the analytical module 122 sets a second threshold, which is the presence of this alternating pattern for six months in a row. If the second threshold is crossed, the first threshold is modified to a credit appearing on invoices of two consecutive months. In addition, the analytical module 122 sets a third threshold, which is a credit on invoices for three months in a row. If this third threshold is crossed, the analytical module 122 suggests renegotiating the deliverable in the contract 103. Further, the analytical module 122 can suggest a modified deliverable definition, based on the performance of similar deliverables in the relational database 101.

Although the method 600 shows three thresholds based on which the actions are taken, the number and type of thresholds, the types of action, the order of the actions may vary and are only limited by the breadth of the recited claims.

Consider another example, where the number of thresholds and types of action are different from the ones described in FIG. 6, however serve the same purpose. A first threshold states that if one month's invoice for a contract 103 includes 3 or more errors, the analytics module 122 will set up a notification reciting the errors to all immediate stakeholders and suggests additional vigilance by the supplier. The second threshold states that if the errors continue to be present for two months consecutively, the analytical module 122 escalates the error notification to higher management. From these examples, it will be clear to those skilled in the art that several implementations of this retrospective approach are possible in the claimed invention.

### Comparative Reporting

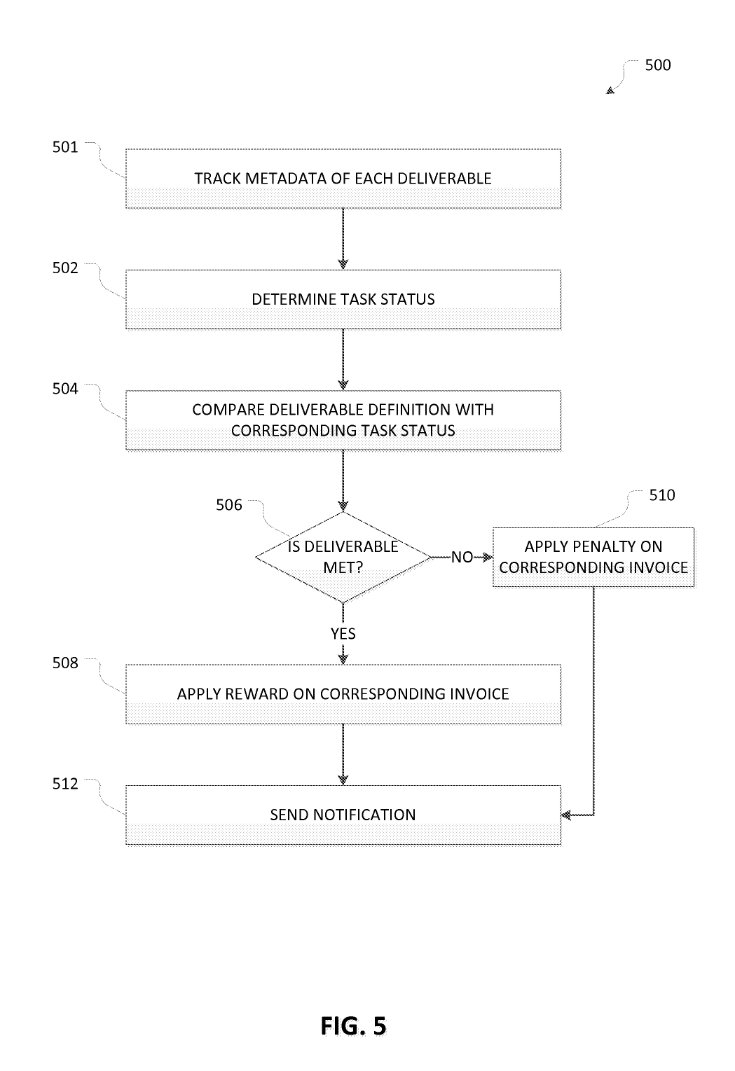

The analytics module 122 can compare metadata 108, 204a, 206a, and 208a, keeping any metadata field 108, 204a, 206a, and 208a common, for example, a supplier, a client, or a task. The reporting module 126 can generate reports representing these comparisons in the form of graphs, tables, charts, etc. across different suppliers and services, as will be described in more detail in relation with FIGS. 7 to 10.

The analytics module 122 can compare the normalized metadata or other metadata across different parameters for example, suppliers, clients, tasks, and so on, to generate comparative insights. FIGS. 7 to 10 illustrate four examples of reports depicting such comparative insights.

### Examples of Comparative Reports

FIG. 7 illustrates an SLA status report 700 comparing SLA performance across different suppliers in a given month. Table 702 represents the SLA status for four suppliers that may be selected by a user. The SLA status colors indicate the following thresholds—green, if at least 95% of the SLAs have been met; yellow, if 93% to 95% of the SLAs have been met; and red: if less than 93% of the SLAs have been met. It will be apparent to those in the art that any number of suppliers may be selected for reporting, and these suppliers may belong to different industry types. Further, the thresholds may be modified as desired, and this modification may be automatic, as explained in relation with FIG. 6. The meters 704 represent the exact percentage of SLAs met by each reported supplier.

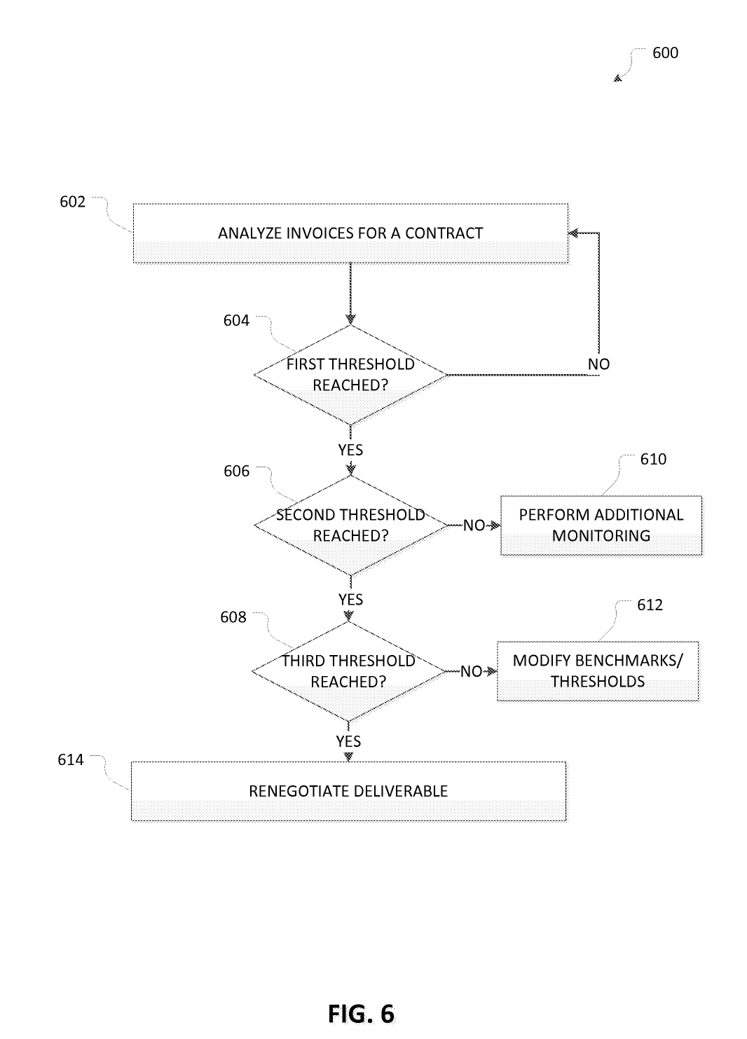

FIG. 8 depicts a chart 800 showing five suppliers having the lowest credit on their invoices over the past year. This chart 800 may be generated for any number of suppliers, for the suppliers of one particular client, or alternatively, for all suppliers regardless of their industry type.

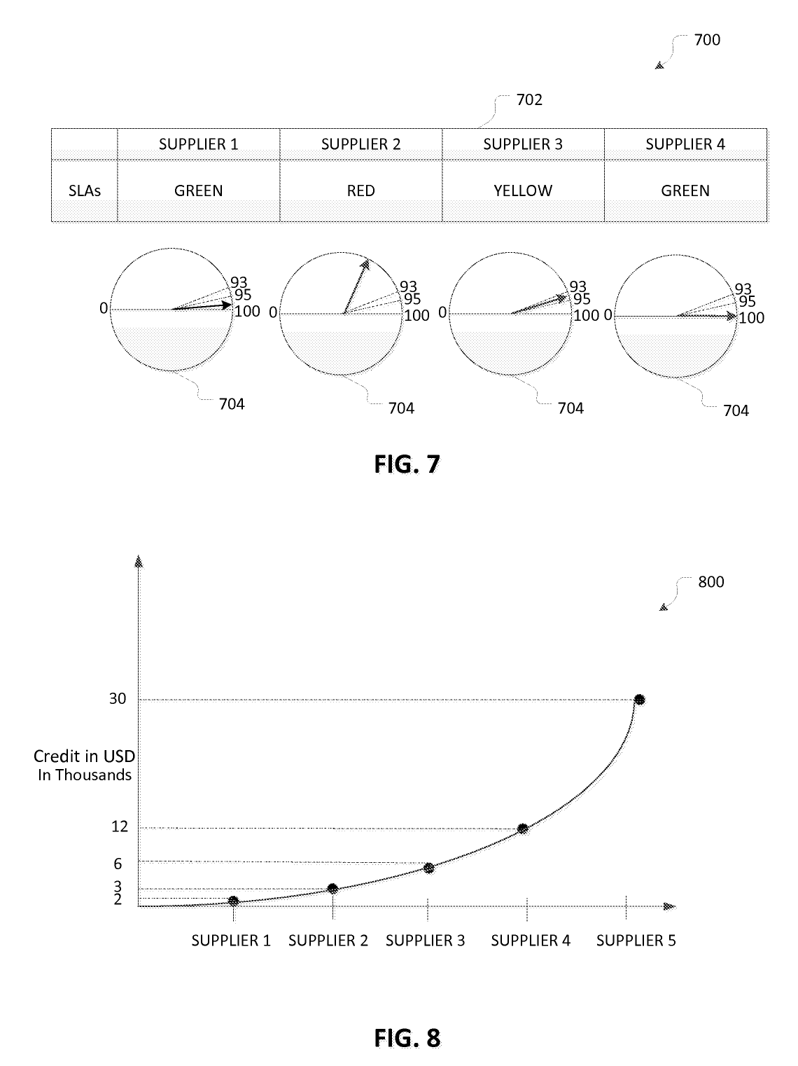

FIG. 9 shows a chart 900 representing the task completion status for three tasks. Two of the tasks belong to client 1 while the third task belongs to client 2. It will be clear to those in the art that the chart 900 may be generated for any task belonging to any client or any supplier.

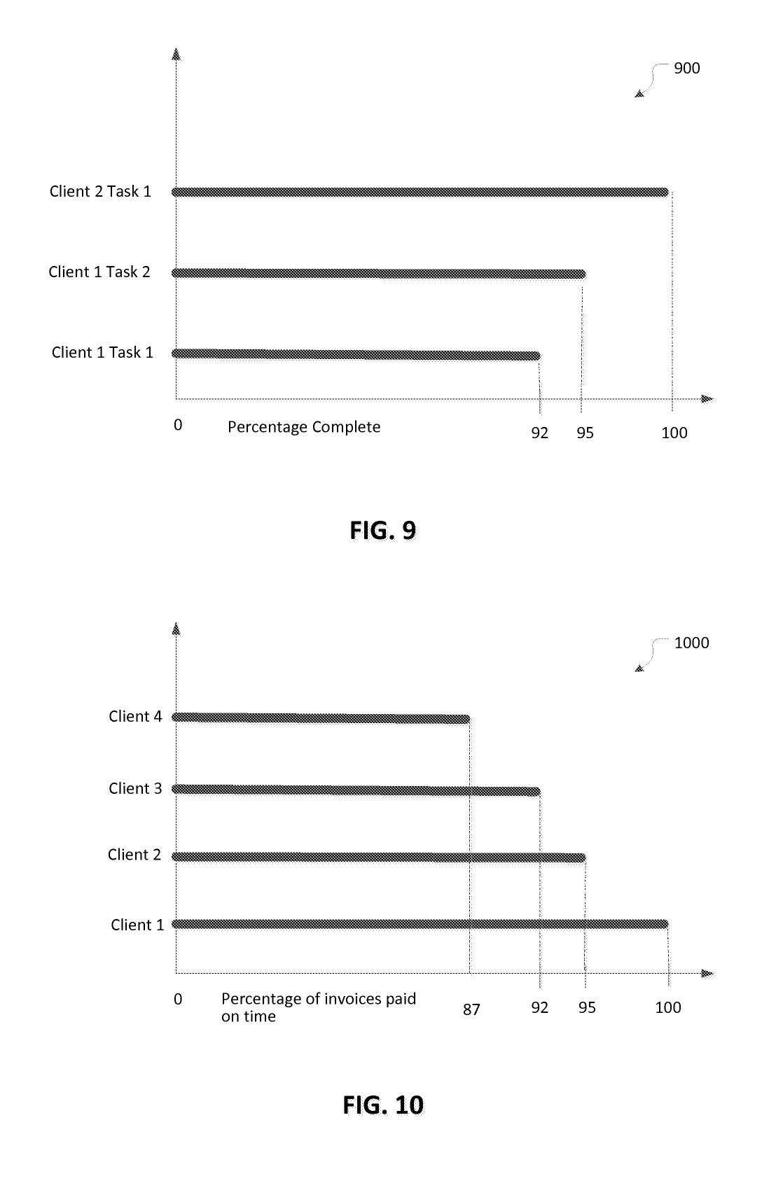

FIG. 10 depicts a chart 1000 representing the top four clients that pay their invoices on time and the percentage of such invoices. Naturally, this chart 1000 may be generated for any number of clients and may be limited, for example, by client industry.

From the FIGS. 7 to 10 it is apparent that graphs, charts, or tables may be generated across any metadata fields to suit a user's requirements. Normalizing the metadata in various contracts facilitates the generation of such comparative reports across industry, client, supplier, tasks, and any other similar metadata extracted by the analytics module 122.

It will be appreciated that several of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

What is claimed is:

1. A method for supplier management comprising:
extracting contract metadata from a contract;
normalizing the contract metadata into a predetermined form;
storing the normalized contract metadata into a relational database which includes metadata related to a plurality of previously executed contracts;
selecting a deliverable from the contract entered into the relational database;
identifying one or more deliverables from the relational database that are similar to the selected deliverable;
comparing the selected deliverable's normalized metadata to the metadata of the identified deliverables;
based on the comparison, determining whether the selected deliverable is likely to be missed; and
upon the determination that the selected deliverable is likely to be missed, performing an appropriate action, including one or more of:
sending a notification;
arranging additional monitoring;
modifying benchmarks/thresholds; or
suggesting renegotiation of the selected deliverable.

2. The method of claim 1, wherein the extracting step further comprises automatically extracting a plurality of deliverables and the corresponding deliverable metadata from the contract being entered into the relational database.

3. The method of claim 1, wherein each previously executed contract in the relational database includes one or more deliverable definitions including one or more of:
a service level agreement (SLA);
a milestone; or
an obligation;
wherein each deliverable has corresponding deliverable metadata.

4. The method of claim 1 further comprising:
defining a client related to the contract;
defining a supplier related to the contract;
defining one or more tasks related to the contract, each task definition corresponding to a deliverable within the contract; and
managing one or more invoices related to the contract.

5. The method of claim 4 further comprising:
tracking metadata of each deliverable;
determining status of one or more tasks;
determining whether the corresponding deliverable has been met, based on the comparison between the deliverable definition and the corresponding task status;
based on whether the deliverable is met, performing one or more of:
crediting a reward to the corresponding invoice;
crediting a penalty to the corresponding invoice; or
sending out a notification.

6. The method of claim 5, wherein the monetary value related to the one or more invoices is modified when a credit is performed.

7. The method of claim 5, wherein the deliverable definition is utilized to define a mathematical rule set used for determining the task status.

8. The method of claim 5 further comprising displaying the comparison between the deliverable definition and the corresponding task status as one or more of:
a graph;
a chart; or
a table.

9. The method of claim 4, wherein the contract metadata in the relational database includes one or more of:
value of contract;
service type;
suppliers involved;
clients involved;
complexity of contract;
geographies involved;
duration of contract; or
clause set.

10. The method of claim 9 further comprising:
comparing metadata across one or more of:
the suppliers;
the services;
the contracts;
the clients;
geographies;
business units; or
the tasks; and
generating a report representing the result of the comparison.

11. The method of claim 4, wherein based on processed invoices, performing an appropriate action including one or more of:
sending a notification;
additional monitoring;
modifying benchmarks/thresholds; or
suggesting renegotiation of the deliverable.

12. The method of claim 1, wherein the method is implemented through one or more of:
a desktop application,
a web application, or
a cloud application.

13. The method of claim 1, wherein the normalizing step further comprises performing predetermined calculations on the metadata.

14. The method of claim 9, wherein the suppliers belong to different vocational fields/industry areas.

15. The method of claim 1, wherein the normalization includes the steps of:
defining a set of synthetic parameters; and
mapping each extracted contract metadata to one or more synthetic parameters.

16. A system for supplier management comprising:
a relational database configured to store metadata related to a plurality of executed contracts, wherein each contract includes one or more deliverables;
an analytics module configured to:
normalize the metadata into a predetermined form before storing the metadata into the relational database;
select a deliverable from a contract entered into the relational database;
identify one or more deliverables from the relational database that are similar to the selected deliverable;
compare the selected deliverable's metadata to the metadata of the identified deliverables;
based on the comparison, determine whether the deliverable is likely to be missed; and
upon the determination that the deliverable is likely to be missed, perform an appropriate action, including one or more of:
send a notification;
arrange additional monitoring;
modify benchmarks/thresholds; or
suggest renegotiation of the deliverable.

17. The system of claim 16, wherein the analytics module is further configured to automatically extract a plurality of deliverables and the corresponding deliverable metadata from the contract being entered into the relational database.

18. The system of claim 16, wherein the relational database includes the contracts, each contract including one or more deliverable definitions including one or more of:
a service level agreement (SLA);
a milestone; or
an obligation;
wherein each deliverable has corresponding deliverable metadata.

19. The system of claim 16 further comprising:
one or more clients definitions;
one or more supplier definitions;
one or more task definitions related to the contract, each task definition corresponding to a deliverable; and
an invoice management module configured to manage one or more invoices related to the contract.

20. The system of claim 19 further comprising a performance management module configured to track one or more metadata of each deliverable; and
wherein the analytics module is further configured to:
receive status of one or more tasks from the performance management module;
determine whether the corresponding deliverable has been met, based on the comparison between the deliverable definition and the corresponding task status;
based on whether the deliverable is met, perform one or more of:
credit a reward to the corresponding invoice;
credit a penalty to the corresponding invoice; or
send out a notification.

21. The system of claim 20, wherein the monetary value related to the one or more invoices is modified when a credit is performed.

22. The system of claim 20, wherein the deliverable definition is utilized to define a mathematical rule set used for determining the task status.

23. The system of claim 20 further comprising a reporting module configured to display the comparison between the deliverable definition and the corresponding task status as one or more of:
a graph;
a chart; or
a table.

24. The system of claim 16, wherein the metadata in the relational database includes one or more of:
value of contract;
service type;
suppliers involved;
clients involved;
complexity of contract;
geographies involved;
duration of contract; or
clause set.

25. The system of claim 24, wherein:
the analytics module is further configured to compare metadata across one or more of:
the suppliers;
the clients;
the services;
the contracts;
geographies;
business units; or
the tasks; and
the reporting module configured to generate a report representing the result of the comparison.

26. The system of claim 20, wherein based on processed invoices, the analytics module is configured to perform an appropriate action including one or more of:
send a notification;
additional monitoring;
modify benchmarks/thresholds; or
suggest renegotiation of the deliverable.

27. The system of claim 16, wherein the system is implemented through one or more of:
a desktop application,
a web application, or
a cloud application.

28. The system of claim 16, wherein the normalization further comprises predetermined calculations on the metadata.

29. The system of claim 25, wherein the suppliers belong to different vocational fields/industry areas.

30. The system of claim 16, wherein the normalization further comprises:
a set of synthetic parameters; and
a mapping of each metadata to one or more synthetic parameters.
